(19) United States
(12) Patent Application Publication
(10) Pub. No.: US 2004/0077242 A1
(43) Pub. Date: Apr. 22, 2004

(54) Composite backing for stabilized carpet

(76) Inventor: Bruce W. Layman, Mount Vernon, TX (US)

Correspondence Address: Frank C. Eymard, Adams and Reese LLP, 4500 One Shell Square, 701 Poydras Street, New Orleans, LA, 70139, US

(21) Appl. No.: 10/272,197

(22) Filed: Oct. 16, 2002

(51) Int. Cl. D03D 15/00; D03D 25/00; D03D 15/08; D03D 17/00; B32B 5/08; B32B 17/02; B32B 27/02; B32B 5/26; B32B 3/02; D04H 11/00; D05C 17/00; D03D 27/00; B32B 33/00; B32B 27/38; B32B 17/10

(52) U.S. Cl. 442/225; 442/182; 442/208; 442/212; 442/220; 442/217; 442/219; 428/414; 428/417; 428/85; 428/95; 428/96; 428/97

(57) ABSTRACT

The present invention provides a composite backing suitable for use in the manufacturing of carpeting, particularly tufted synthetic turf carpeting, or any other fabric product where dimensional stability in the presence of thermal or moisture gradients is desirable. The composite backing comprises reinforcement strands integrated into a woven backing fabric. The reinforcement strands may be laid in an open network structure needlepunched into a woven backing or may also be integrated into the woven backing by directly weaving the reinforcement strands into the woven backing as it is being fabricated. A synthetic turf product may be constructed by tufting the composite backing.

### STATEMENT REGARDING FEDERALLY SPONSORED RESEARCH OR DEVELOPMENT

Not Applicable

### FIELD OF THE INVENTION

The present invention relates broadly to an improved composite backing suitable for stabilizing carpet. More particularly, the present invention relates to an improved backing, comprising an open network structure of reinforcement strands and a woven backing fabric, integrally constructed as a composite backing for use in applications where thermal and moisture stability is desirable, particularly for the manufacture of synthetic turf carpeting.

### BACKGROUND OF THE INVENTION

Conventional carpets are generally constructed by incorporating a piling yarn into a primary backing fabric to form piles of yarn, which project from the surface of the primary backing fabric. Carpet construction methods include weaving, tufting, needlepunching, flocking and knitting.

The majority of the world's conventional carpet production utilizes tufting technology to incorporate the piling yarn into the primary backing fabric. The tufting process is similar to the action of a conventional sewing machine. Yarn is fed by yarn bobbins to needles that stitch loops of yarn through the primary backing. The loops can either be cut with a blade or left intact to create different pile finishes. The underside of the tufted primary backing can be sealed with an adhesive to lock the back loops of the tufted yarn to the primary backing. Some tufted carpeting is constructed by stitching yarn through two or more layers of primary backing. For example, see U.S. Pat. No. 4,426,415, which discloses multiple primary backing layers having different gauges.

A secondary backing fabric has also been used to hold the tufted yarn in place, as well as to impart dimensional stability to the carpet. The secondary backing fabric is typically attached to the primary backing fabric by a latex or other binding adhesive applied to the backstitched side of the primary backing fabric.

Many variations of backing construction for use with tufted carpeting can be found in the prior art. For example, U.S. Pat. No. 3,922,454 discloses a secondary backing comprising a woven synthetic scrim with a layer of staple fibers needled onto the top surface of the scrim with portions of the fibers projecting through to the bottom surface of the scrim. A latex coating is applied to bond the fibers to the bottom surface of the scrim. The secondary backing is then adhered to the backside of the primary backing.

U.S. Pat. No. 4,305,986 discloses a tufted carpeting having a secondary backing anchored by PVC latex or rubber to a primary backing. The secondary backing comprises a non-woven fabric made of several superimposed layers of polyester and/or co-polyester endless filaments or threads which are deposited in layers in a tangled arrangement such that they cross over and are bonded at their points of intersection with the aid of a binder.

U.S. Pat. No. 4,871,603 discloses a carpet tile that has an integral backing material of non-woven synthetic fibers intermingled or needled together and laminated to the carpet base by an adhesive layer, polyolefin, modified polyolefin, polyamide, or other suitable thermoplastic material, which is embedded with a layer of glass scrim. The non-woven layer consists of substantially all synthetic fibers such as polyester, nylon and the like held together in the layer by conventional methods of needle punching or air layering.

U.S. Pat. No. 5,470,648 discloses a composite non-woven fabric having dual layers of entangled, non-bonded nylon filaments sandwiching a reinforcing component of fiberglass scrim adhesively attached to each nylon layer. One application for the disclosed composite fabric is as a non-woven carpet backing.

Finally, U.S. Pat. No. 6,299,959 discloses a backing fabric comprising a woven polypropylene upper layer and a lower layer consisting of a non-woven fabric saturated with a binder and calendared with fiberglass to form a reinforcing matrix. The two backing layers are simultaneously fed through a tufting machine.

While tufted carpeting makes up the majority of conventional carpeting manufacturing, other methods of carpet construction continue to find modern applications. The knitting process is one such method. The primary difference between tufted and knitted carpeting is that a knitted carpet's backing yarns and piling yarns are knitted directly into the backing as the backing is being fabricated yielding stronger, more stable carpets. As with tufted carpet products, reinforced secondary backing systems have been used in conjunction with knitted carpet products as well.

Many of the backing systems disclosed in the prior art are utilized in the manufacture of tufted and knitted synthetic turf carpeting. Once installed, tufted and knitted synthetic turf products are often exposed to varying environmental conditions. Temperature and moisture gradients can cause the carpeting to expand and contract, which can result in buckling across the surface of the synthetic turf. While reinforced backing systems have been used to stabilize the synthetic turf, the present invention offers several advantages over conventional backing systems.

### SUMMARY OF THE INVENTION

The present invention provides a composite backing suitable for use in the manufacturing of carpeting, particularly tufted synthetic turf carpeting, or any other fabric product where dimensional stability in the presence of thermal or moisture gradients is desirable. The composite backing comprises reinforcement strands integrated into a woven backing fabric. The reinforcement strands may be laid in an open network structure typically referred to as a scrim, and needlepunched into a woven backing fabric. The needling process fibrillates the weft and warp yarns of the woven backing fabric to create a fibrous batt, or mass of fibers, on both sides of the woven backing fabric. The needles simultaneously interlock the reinforcement strands of the scrim within the fibrous batt. The reinforcement strands may also be integrated into the woven backing fabric by directly weaving the reinforcement strands into the woven backing fabric as it is being fabricated. The reinforcement strands may be constructed of numerous materials having low coefficients of thermal expansion, high strength, low water absorption and good fatigue and creep properties, such as carbon fibers, aramid fibers, glass fibers or the like, used alone or in combination with other materials. Once the reinforcement strands have been needlepunched or knitted into the woven backing fabric, a synthetic turf product may be constructed by tufting the composite backing. Alternatively, a synthetic turf product may be constructed by knitting the reinforcement strands into a knitted synthetic turf product, such as the knitted synthetic turf disclosed in pending U.S. patent application Ser. No. 09/766,236, which is herein incorporated by reference.

Multiple reinforcing scrims can also be needlepunched with a woven backing fabric in substantially the same method as a single reinforcing scrim. The multiple reinforcing scrims are interlocked within the fibrous batt on both sides of the woven backing fabric as all three components are simultaneously needlepunched.

While reinforcing scrims have been used as part of conventional carpet backing systems, their application has been limited to secondary backing systems or multiple-layered primary backing systems. Conventional tufted carpet backing systems employ a reinforcing scrim with a non-woven fabric carrier. When utilized alone as a primary backing for tufted synthetic turf carpeting, the non-woven fabric carrier in combination with the reinforcing scrim often does not survive the tufting process, which causes the non-woven fabric to tear. The prior art non-woven/reinforcing scrim combination works well as a secondary backing because secondary backings are applied after the tufting process. When used as part of a multiple-layered primary backing, the other layers prevent the tearing of the non-woven/reinforcing scrim combination during tufting. The present invention improves upon these conventional systems by providing a single-layer composite backing that can be tufted without damaging the backing and also provides dimensional stability in the presence of thermal and moisture gradients.

The elimination of the reinforced secondary backing or multiple primary backings from the carpet system reduces manufacturing expense as compared to conventional backing systems in several ways. Raw material expense is directly reduced. Also, the viscosity and volume of liquid applied coatings used to secure the piling yarn to the carpet backing can be reduced without affecting penetration of the coating. This is primarily due to the lack of a non-woven carrier component, which absorbs the coating in prior art backings. In addition to the decreased expense due to the reduction in viscosity and volume of the liquid applied coating, the curing time associated with the liquid coating is also reduced, which results in increased production rates.

The synthetic turf carpet manufactured according to the present invention may be used to build an athletic playing surface. First the ground is prepared for the installation of the athletic playing surface, which may include the installation of a suitable aggregate base for drainage. The aggregate base may comprise a single layer of aggregate material or multiple layers of material comprising aggregates of different particle size. Geotextile membranes maybe incorporated into the playing surface. Porous geotextile membranes may be employed to improve drainage and non-porous geotextile membranes may be employed to protect the underlying foundation or to direct surface water to sub-grade drainage systems, such as perforated or slotted pipe systems. Shock absorbent pads can be installed on the aggregate base if necessary for the athletic application. The prepared synthetic turf carpet can then be installed upon the aggregate base and shock absorbent pad, if employed. The synthetic turf carpet of the present invention may be installed as either a filled or non-filled turf system.

### BRIEF DESCRIPTION OF THE DRAWINGS

FIG. 1 is an illustration of one preferred embodiment of a woven backing fabric utilized in manufacturing the composite backing of the present invention.

FIG. 2 is an illustration of one preferred embodiment of an open network structure of reinforcement strands, or scrim, utilized in manufacturing of a needlepunched composite backing of the present invention.

FIG. 3 is an illustration of one preferred embodiment of the needlepunch process used to integrate the woven backing fabric and the reinforcement strands of the scrim.

FIG. 4 is a side-perspective view of a preferred embodiment of the composite backing featuring the reinforcement strands of the scrim interlocked within the fibrous batt created by needling the woven backing fabric and the scrim, and also featuring a tuft of piling yarn stitched through the composite backing.

FIG. 5 is an illustration of one preferred embodiment of the composite backing featuring the reinforcement strands knitted into the backing warp and weft yarns of a woven backing fabric.

### PREFERRED EMBODIMENTS OF THE INVENTION

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

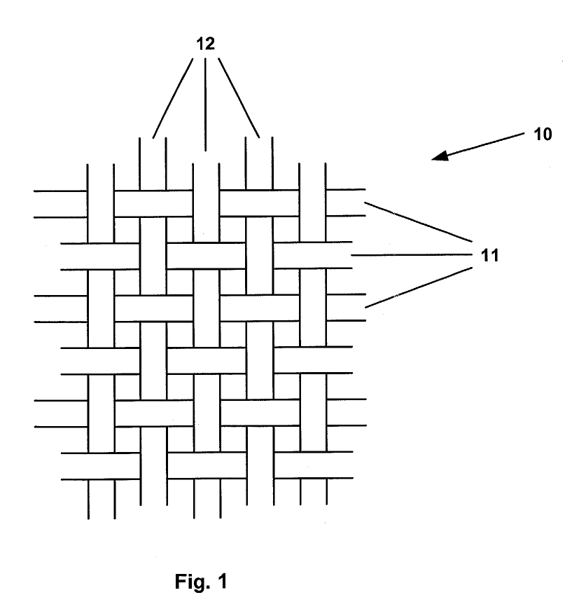

As shown in FIG. 1, woven backing fabric 10 comprises warp yarns 12 and weft yarns 11. A single warp yarn 12, also known as an end, runs lengthwise across a loom during manufacturing of the woven backing fabric 10. The weft yarn 11, also known as a pic, is interlaced between the ends. Woven fabric construction may vary by the number of ends and pics per inch of woven fabric and also by the type of material used to create the yarn. For synthetic turf applications, the woven backing fabric 10 is typically made from yarns of polyolefin, polyamide, polyester, polyethylene terephthalte, polytrimethylene teraphthalate or composites of these fibers. Polypropylene fibers are the preferred material in the manufacturing of woven fabrics for use as a backing for tufted synthetic turf carpet and the number of yarns per inch varies from about 7 to about 21 for both the ends and pics. Synthetic fibers have replaced natural or staple fibers, such as cotton, wool, hemp, jute or the like, in the manufacturing of woven fabrics utilized for carpet backings. Nevertheless, woven fabrics for use in accordance with the present invention may be manufactured from either natural or synthetic fibers.

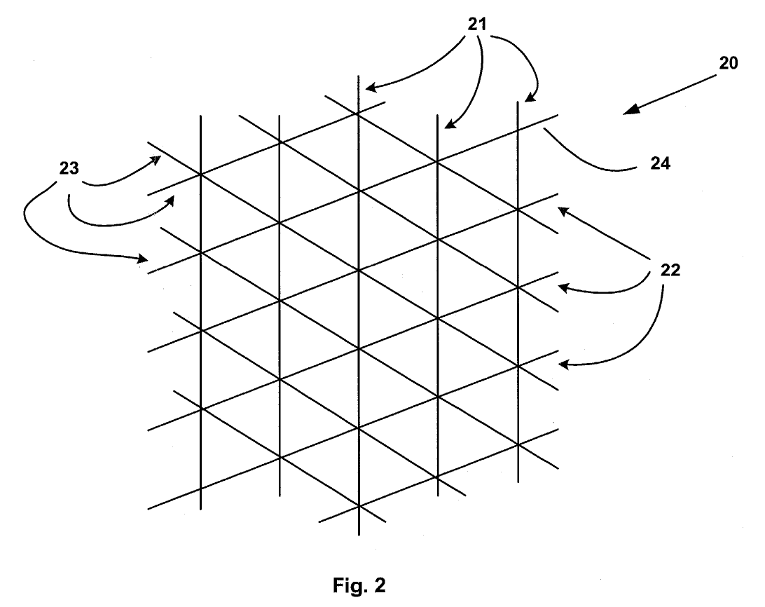

FIG. 2 shows a preferred embodiment of a reinforcing scrim 20. The scrim 20 has an open network structure made of reinforcing strands 24. The open network may or may not be woven. The reinforcing strands 24 are preferably made, in whole or in part, from materials that have low coefficients of thermal expansion, high strength, low water absorption and good fatigue and creep properties, such as carbon fibers, aramid fibers or glass fibers, and the like. Glass fibers are the preferred material of construction. The glass fiber scrim may be manufactured by techniques known in the art, such as those disclosed in U.S. Pat. Nos. 3,728,195, 4,030,168, and 4,762,744, the disclosures of which are hereby incorporated by reference. The preferred embodiment of reinforcing scrim 20 shown in FIG. 2 is commonly referred to as a triaxial scrim. Parallel groups of reinforcing strands 24 extend in three different directions 21, 22, 23.

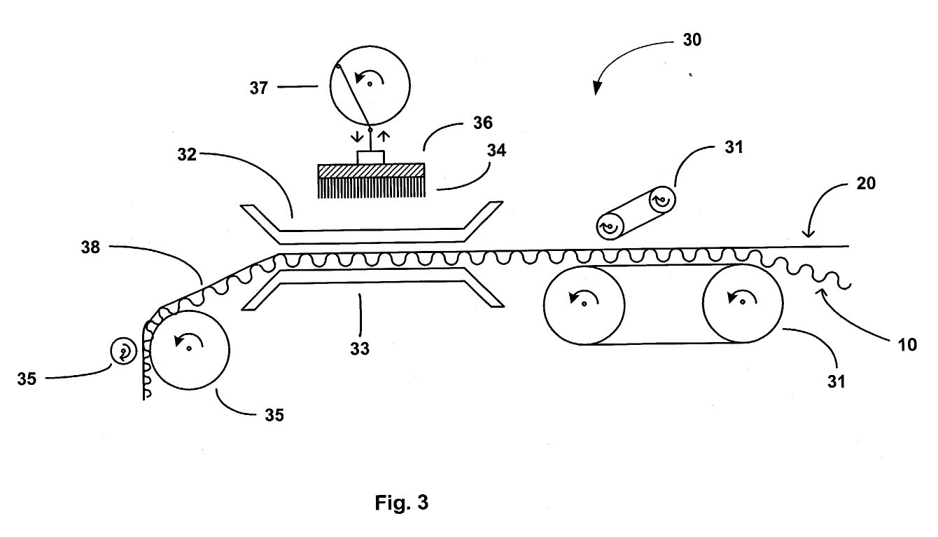

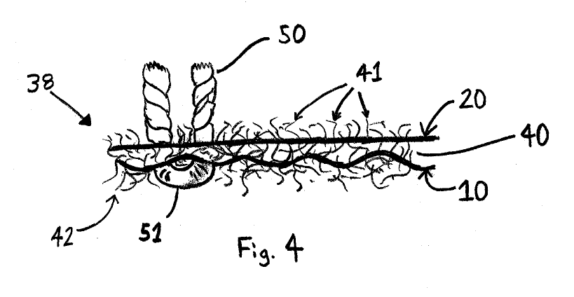

FIG. 3 illustrates the needlepunch process employed to integrate the woven backing fabric 10 and the reinforcing scrim 20. Generally, the woven backing fabric 10 and the reinforcing scrim 20 are simultaneously fed into a needlepunch apparatus 30 through a series of feed rollers 31. While the reinforcing scrim 20 may be fed into the needlepunch apparatus 30 either above or below the woven backing fabric 10, the preferred method is to feed the reinforcing scrim 20 above the woven backing fabric 10. The two contiguous components 10, 20 proceed through the feed rollers 31 and between an upper holeplate 32 and a lower holeplate 33. While the two contiguous components 10, 20 travel between the upper and lower holeplates 32,33, a needleboard 36, comprising a plurality of needles 34 and driven by a reciprocating mechanism 37, repeatedly penetrates the upper and lower holeboards 32, 33 and the two contiguous components 10, 20 traveling between them. As the needles 34 penetrate the two contiguous components 10, 20, the warp and weft yarns 11, 12 of the woven backing fabric 10 are fibrillated, creating a fibrous batt 40 on both sides of the woven fabric 10. Concurrent with the creation of the fibrous batt 40, which is best seen in FIG. 4, the needles 34 interlock the individual strands 24 of the reinforcing scrim 20 within the individual fibers 41 of the fibrous batt 40. The resulting integrated composite backing 38 exits from between the upper and lower holeplates 32, 33 through a series of exit rollers 35.

Alternative configurations of the needlepunch apparatus 30 may also be utilized to manufacture the composite backing 38, such as apparatuses that employ multiple needleboards 34 in series or multiple needleboards 34 both above and below the upper and lower holeplates 32, 33.

Following needlepunching of the woven backing fabric 10 and the reinforcing scrim 20, the composite backing 38 maybe tufted as illustrated in FIG. 4. Preferably, the composite backing 38 is tufted with the reinforcing scrim 20 facing in the upward direction, which results in the backstitch side 51 of the tuft 50 secured against the woven backing fabric face 42 of the composite backing 38. After tufting, the composite backing may be coated with a latex or polyurethane binder to lock in the backstitch side 51 of the tuft 50 against the woven backing fabric face 42.

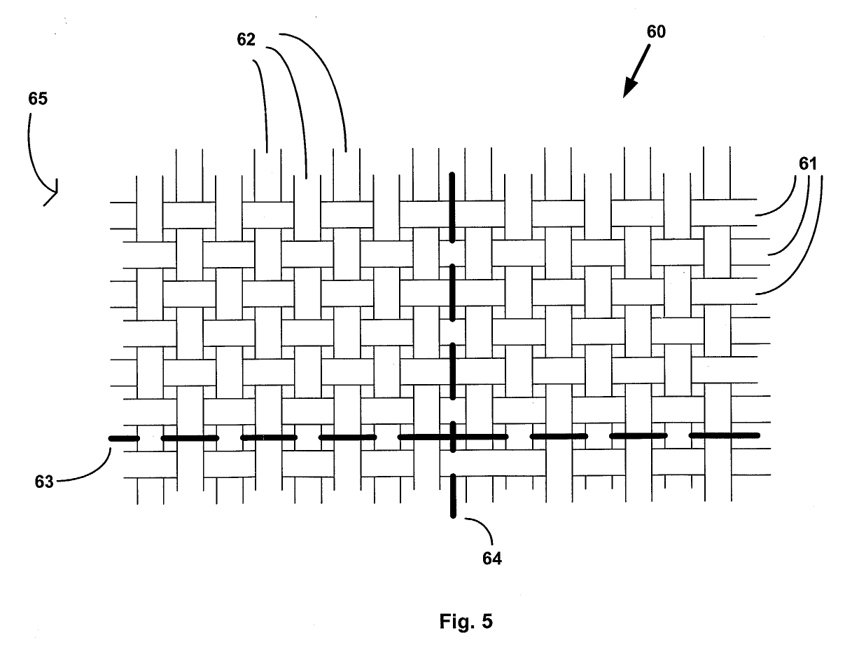

FIG. 5 illustrates a preferred embodiment of a composite backing 60 wherein the reinforcement strands 63, 64 are integrated into the woven backing fabric 65 by incorporating the reinforcement strands 63, 64 into the woven backing fabric 65 as it is manufactured. Warp reinforcement strands 64 may be employed between the warp yarns 62 of the woven fabric backing 65 or weft reinforcement strands 63 may be knitted between weft yarns 61 of the woven fabric backing 65. Using reinforcement strands in a single orientation will provide dimensional stability across a single dimension. Alternatively, as shown in FIG. 5, if multi-dimensional stability is desired, reinforcement strands may be used between both the warp yarns 62 and weft yarns 61 of the woven backing fabric 65. While the number of reinforcement strands per inch of woven fabric backing 60 may vary, using at least one reinforcement strand per inch of woven fabric backing 60 should impart sufficient dimensional stability to the composite fabric 60 for use as a backing in most synthetic turf applications.

After fabrication, the composite backing 60 may be tufted and, similar to the needlepunched composite backing, the composite backing 60 may be coated with a latex or polyurethane binder to lock in the piling yarn to the backstitched face of the composite backing 60.

Composite backing 60 may alternatively be incorporated into a knitted synthetic turf carpet by concurrently knitting pile yarns directly into the composite backing 60 as it is being fabricated.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A composite fabric comprising: a woven component having warp yarns and weft yarns, a reinforcing component on said woven component, said reinforcing component comprising an array of reinforcement strands laid in an open network structure, said woven component and said reinforcing component fibrillated together to thereby form a fibrous batt, said fibrous batt maintaining said woven component and said reinforcing component as an integrated fabric.

2. The composite fabric of claim 1, wherein said warp yarns and said weft yarns of said woven component are manufactured of a material selected from the group consisting of polyolefins, polyamides, polyesters, polyethylene terephthalate, polytrimethylene terephthalate, and natural fibers.

3. The composite fabric of claim 1, wherein said warp yarns and said weft yarns of said woven component are manufactured of polypropylene.

4. The composite fabric of claim 1, wherein said woven component comprises 18 warp yarns per inch and 18 weft yarns per inch.

5. The composite fabric of claim 1, wherein said reinforcing component comprises an array of glass strands laid in an open network structure.

6. The composite fabric of claim 5, wherein said open network structure of said glass strands extend in at least two different directions.

7. The composite fabric of claim 6, wherein said open network structure of said glass strands extend in three different directions.

8. A composite fabric comprising: a first reinforcing component, a woven component on said first reinforcing component, said woven component having warp yarns and weft yarns, a second reinforcing component on said woven component, said first and said second reinforcing components comprising an array of reinforcement strands laid in an open network structure, said woven component and said first and said second reinforcing components fibrillated together to thereby form a fibrous batt, said fibrous batt maintaining said woven component and said first and said second reinforcing components as an integrated fabric.

9. The composite fabric of claim 8, wherein said warp yarns and said weft yarns of said woven component are manufactured of a material selected from the group consisting of polyolefins, polyamides, polyesters, polyethylene terephthalate, polytrimethylene terephthalate, and natural fibers.

10. The composite fabric of claim 8, wherein said warp yarns and said weft yarns of said woven component is manufactured of polypropylene.

11. The composite fabric of claim 8, wherein said woven component comprises 7 warp yarns per inch and 7 weft yarns per inch.

12. The composite fabric of claim 8, wherein said first and said second reinforcing components comprise an array of glass strands laid in an open network structure.

13. The composite fabric of claim 12, wherein said open network structure of said glass strands extend in at least two different directions.

14. The composite fabric of claim 13, wherein said open network structure of said glass strands extend in three different directions.

15. A synthetic turf carpet comprising a piling yarn, a composite fabric backing comprising a woven component having warp and weft yarns, a reinforcing component on said woven component, said reinforcing component comprising an array of reinforcement strands laid in an open network structure, said woven component and said reinforcing component fibrillated together to thereby form a fibrous batt, said fibrous batt maintaining said woven component and said reinforcing component as an integrated fabric, said piling yarn being tufted into said composite fabric backing, and an adhesive coating binding said piling yarn to said composite fabric backing.

16. The synthetic turf carpet of claim 15, wherein said warp yarns and said weft yarns of said woven component is manufactured of a material selected from the group consisting of polyolefins, polyamides, polyesters, polyethylene terephthalate, polytrimethylene terephthalate, and natural fibers.

17. The synthetic turf carpet of claim 15, wherein said warp yarns and said weft yarns of said woven component is manufactured of polypropylene.

18. The synthetic turf carpet of claim 15, wherein said reinforcing component comprises an array of glass strands laid in an open network structure.

19. The synthetic turf carpet of claim 18, wherein said open network structure of said glass strands extend in at least two different directions.

20. The synthetic turf carpet of claim 19, wherein said open network structure of said glass strands extend in three different directions.

21. A synthetic turf carpet comprising a piling yarn, a composite fabric backing comprising a first reinforcing component, a woven component on said first reinforcing component, said woven component having warp yarns and weft yarns, a second reinforcing component on said woven component, said first and said second reinforcing components comprising an array of reinforcement strands laid in an open network structure, said woven component and said first and said second reinforcing components fibrillated together to thereby form a fibrous batt, said fibrous batt maintaining said woven component and said first and said second reinforcing components as an integrated fabric, said piling yarn being tufted into said composite fabric backing, and an adhesive coating binding said piling yarn to said composite fabric backing.

22. The synthetic turf carpet of claim 21, wherein said warp yarns and said weft yarns of said woven component are manufactured of a material selected from the group consisting of polyolefins, polyamides, polyesters, polyethylene terephthalate, polytrimethylene terephthalate, and natural fibers.

23. The composite fabric of claim 21, wherein said warp yarns and said weft yarns of said woven component is manufactured of polypropylene.

24. The composite fabric of claim 21, wherein said woven component comprises 7 warp yarns per inch and 7 weft yarns per inch.

25. The composite fabric of claim 21, wherein said first and said second reinforcing components comprise an array of glass strands laid in an open network structure.

26. The composite fabric of claim 25, wherein said open network structure of said glass strands extend in at least two different directions.

27. The composite fabric of claim 26, wherein said open network structure of said glass strands extend in three different directions.

28. A method of making a composite fabric having dimensional stability in the presence of thermal and moisture gradients comprising the steps of: combining a reinforcing component and a woven component together, said reinforcing component comprising an array of reinforcement strands laid in an open network structure, said open network structure of said reinforcing strands extending in at least two different directions, and simultaneously needlepunching said reinforcing component and said woven component to thereby form a fibrous batt, said fibrous batt maintaining said reinforcing component and said woven component as an integrated fabric.

29. The method according to claim 28, wherein said reinforcing component comprises an array of glass strands laid in an open network structure.

30. The method according to claim 28, wherein said woven component is manufactured of a material selected from the group consisting of polyolefins, polyamides, polyesters, polyethylene terephthalate, polytrimethylene terephthalate, and natural fibers.

31. The method according to claim 28, wherein said woven component is manufactured of polypropylene.

32. A method of making a synthetic turf carpet comprising the steps of: forming a composite fabric backing by combining a reinforcing component and a woven component together, said reinforcing component comprising an array of reinforcement strands laid in an open network structure, said open network structure of said reinforcing strands extending in at least two different directions, and simultaneously needlepunching said reinforcing component and said woven component to thereby from a fibrous batt, said fibrous batt maintaining said reinforcing component and said woven component as an integrated fabric; stitching a piling yarn through said composite fabric backing thereby forming a pile face side and a backstitch side of said synthetic turf carpet; and coating said backstitch side of said synthetic turf carpet with an adhesive binder.

33. The method according to claim 32, wherein said woven component is manufactured of a material selected from the group consisting of polyolefins, polyamides, polyesters, polyethylene terephthalate, polytrimethylene terephthalate, and natural fibers.

34. The method according to claim 32, wherein said woven component is manufactured of polypropylene.

35. The method according to claim 32, wherein said reinforcing component comprises an array of glass strands laid in an open network structure.

36. A method of making a synthetic turf carpet comprising the steps of: forming a composite fabric backing by combining a first reinforcing component, a woven component and a second reinforcing component together, said first and said second reinforcing components comprising an array of reinforcement strands laid in an open network structure, said open network structure of said reinforcing strands extending in at least two different directions, and simultaneously needlepunching said first reinforcing component, said woven component and said second reinforcing component to thereby from a fibrous batt, said fibrous batt maintaining said first and said second reinforcing components and said woven component as an integrated fabric; stitching a piling yarn through said composite fabric backing thereby forming a pile face side and a backstitch side of said synthetic turf carpet; and coating said backstitch side of said synthetic turf carpet with an adhesive binder.

37. The method according to claim 36, wherein said woven component is manufactured of a material selected from the group consisting of polyolefins, polyamides, polyesters, polyethylene terephthalate, polytrimethylene terephthalate, and natural fibers.

38. The method according to claim 36, wherein said woven component is manufactured of polypropylene.

39. The method according to claim 36, wherein said reinforcing component comprises an array of glass strands laid in an open network structure.

40. A woven composite fabric having dimensional stability in the presence of thermal and moisture gradients comprising about 7 to about 21 warp yarns per inch, about 7 to about 21 weft yarns per inch, and a plurality of interlaced reinforcement strands extending in at least one direction.

41. The woven composite fabric of claim 40, wherein said plurality of interlaced reinforcement strands are manufactured of glass.

42. The woven composite fabric of claim 40, wherein said reinforcement strands are interlaced at least once per inch.

43. The woven composite fabric of claim 40, wherein said warp yarns and said weft yarns are manufactured of a material selected from the group consisting of polyolefins, polyamides, polyesters, polyethylene terephthalate, polytrimethylene terephthalate, and natural fibers.

44. The woven composite fabric of claim 40, wherein said warp yarns and said weft yarns are manufactured of polypropylene.

45. A synthetic turf carpet comprising a piling yarn, a woven composite fabric backing having dimensional stability in the presence of thermal and moisture gradients comprising warp yarns, weft yarns, and a plurality of interlaced reinforcement strands extending in at least one direction, said piling yarn being tufted into said woven composite fabric backing, and an adhesive coating binding said piling yarn to said composite fabric backing.

46. The synthetic turf carpet of claim 45, wherein said plurality of interlaced reinforcement strands are manufactured of glass.

47. The synthetic turf carpet of claim 45, wherein said reinforcement strands are interlaced at least once per inch.

48. The synthetic turf carpet of claim 45, wherein said woven composite fabric backing comprises about 7 to about 21 warp yarns per inch.

49. The synthetic turf carpet of claim 45, wherein said woven composite fabric backing comprises about 7 to about 21 weft yarns per inch.

50. The synthetic turf carpet of claim 45, wherein said warp yarns and said weft yarns are manufactured of a material selected from the group consisting of polyolefins, polyamides, polyesters, polyethylene terephthalate, polytrimethylene terephthalate, and natural fibers.

51. The synthetic turf carpet of claim 45, wherein said warp yarns and said weft yarns are manufactured of polypropylene.

52. A method of making a synthetic turf carpet comprising the steps of: forming a composite fabric backing by simultaneously weaving warp yarns and weft yarns and interlacing a plurality of reinforcement strands in at least one direction; stitching a piling yarn through said composite fabric backing thereby forming a pile face side and a backstitch side of said synthetic turf carpet; and coating said backstitch side of said synthetic turf carpet with an adhesive binder.

53. The method according to claim 50, wherein said plurality of interlaced reinforcement strands are manufactured of glass.

54. The method according to claim 50, wherein said reinforcement strands are interlaced at least once per inch.

55. The method according to claim 50, wherein said composite fabric backing comprises about 7 to about 21 warp yarns per inch.

56. The method according to claim 50, wherein said composite fabric backing comprises about 7 to about 21 weft yarns per inch.

57. The method according to claim 50, wherein said warp yarns and said weft yarns are manufactured of a material selected from the group consisting of polyolefins, polyamides, polyesters, polyethylene terephthalate, polytrimethylene terephthalate, and natural fibers.

58. The method according to claim 50, wherein said warp yarns and said weft yarns are manufactured of polypropylene.
